(19) United States
(12) Patent Application Publication
(10) Pub. No.: US 2005/0126845 A1
(43) Pub. Date: Jun. 16, 2005

(54) Attenuating foam insert and method for manufacture

(76) Inventors: Michael A. Vaudrey, Blacksburg, VA (US); Yu Du, Christiansburg, VA (US); William R. Saunders, Blacksburg, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 11/009,744

(22) Filed: Dec. 10, 2004

Related U.S. Application Data
(60) Provisional application No. 60/528,459, filed on Dec. 10, 2003.

(51) Int. Cl. H04R 25/00

(52) U.S. Cl. 181/129

(57) ABSTRACT

A shaped acoustic foam insert for use in improving the performance of circumaural hearing protectors is described. A foam block having a cross-section and shape is adapted to occupy the entire interior volume of an earcup of a circumaural hearing protector. The insert has no folds or open acoustic cavities. The surface of the insert that faces the ear of the user of the circumaural hearing protector comprises a curvilinear groove. The groove has no sharp angles and accommodates the average human pinna. A system and method of manufacturing the attenuating foam insert are provided.

### CROSS REFERENCE TO RELATED APPLICATIONS

This application claims priority under 35 U.S.C. § 119(e) from provisional application No. 60/528,459 filed Dec. 10, 2003. The 60/528,459 application is incorporated by reference herein, in its entirety, for all purposes.

### BACKGROUND

The present invention relates generally to hearing protection. More specifically, embodiments of the present invention provide a foam insert design, and method of manufacture for circumaural hearing protectors.

Passive noise reducing circumaural hearing protectors are widely used in commercial, industry, and military applications where hearing protection from high level ambient noise is important. It is well known through past studies that the low-to-mid frequency noise attenuating properties of circumaural hearing protectors are generally controlled by the seal effectiveness and the vibration response of the earcup system. As a result, the majority of recent technology improvements have focused on designing new earcup seals that ensure a more uniform contact area around the ear with the objective of reducing earcup leakage.

The low-to-mid frequency attenuation performance of a circumaural hearing protector can be limited by two primary mechanisms. The acoustic leak that is formed between a flexible earseal and the human head is virtually unavoidable. Eyeglasses, hair, the jawbone, improper fitting or an inferior earseal product can all be contributing factors for creating or enlarging a gap between the head and hearing protector. This gap allows ambient noise to enter the interior of the earcup and expose the user to harmful noise. The size of the gap will determine to what extent the noise enters the earcup in terms of both magnitude and frequency.

The second mechanism that limits attenuation of the circumaural hearing protector is a vibration mode of the headset itself where the mass is usually controlled by the earcup's mass and the stiffness and damping are controlled by the earseal material and design, the interior earcup volume, and the headband. Increasing the stiffness of the earseal can increase low frequency attenuation. Increasing the mass of the earcup may increase the high frequency attenuation. Both of these techniques lead toward more undesirable solutions in terms of comfort for the user. Heavy earcups bolted to the head through an inflexible seal may be a theoretically ideal solution, but do not represent a practically realizable design.

In the past, hearing protector design has focused on increasing cup volume to increase low frequency attenuation, increasing headband stiffness, increasing seal stiffness, and addressing the leak by creating more comfortable and dynamically stiff seals that conform well to the head. As a result, the impact of the interior cup acoustics has been largely overlooked as a possible way to improve performance. Here performance is referred to as an increase in attenuation and/or a decrease in the standard deviation as measured through a real-ear attenuation at threshold (REAT) attenuation test. Increasing attenuation and decreasing standard deviation both lead to increases in the noise reduction rating (NRR) a metric that industry frequently uses to quantify the expected attenuation a hearing protector would have across a population, for an A-weighted broadband pink noise spectrum.

In prior art and existing circumaural hearing protector products, the interior space of an earcup is lined with an open cell or closed cell acoustic foam. For absorption, open cell foam is more effective while closed cell foam is more effective for increased transmission loss. However, the leak between either the seal and the earcup or the seal and the wearer's head is what most often controls the attenuation properties of the circumaural hearing protector. Studies leading up to the invention disclosed here have revealed that with current seal and earcup technologies, acoustic absorption is more effective at reducing the overall sound pressure level (SPL) at the user's ear because it absorbs more of the sound that enters through the seal leak than conventional foam designs.

FIGS. 1 through 4 illustrate one example of a prior art foam absorption layer typically used in commercial and military products. In FIG. 1, an isometric view of an earcup 102 is illustrated with the foam piece 101 (also illustrated flattened in FIG. 4) folded to approximately cover the interior wall of the earcup. FIGS. 2 and 3 illustrate cross sectional views of FIG. 1 from both sides. The foam 120 and 130 is folded into the earcup 121 and 131. This design is typically used with an open cell or closed cell foam material. However, it has been demonstrated, consistent with the findings of this invention, that the open cell foam provides a higher NRR. This is consistent with absorption of sound inside the earcup being the more important mechanism for attenuation (as opposed to transmission through the earcup/foam). The two-dimensional foam cross of FIG. 4 cannot exactly mate with the interior shape of the curved earcup. The earcup is curved to make the shell more rigid to structural vibration modes. Gaps between the foam and the shell 103, 122, and 132, reduce the absorptive effectiveness of the thin foam layer and introduce acoustic cavities that may have resonances of their own, contributing to an increase in SPL inside the earcup.

FIGS. 5 and 6 also illustrate another example of foam used in another existing product. The foam 151 fits inside an earcup 150. At the interface between the wall of the earcup 152 and the foam, a flat exposed surface is apparent which also creates a rigid corner boundary. This exposed, rigid surface and corner boundary condition result in a reduction in possible acoustic absorption. FIG. 6 is an isometric illustration of the acoustic foam insert illustrated in cross section in FIG. 5.

Prior art foam absorption layers used inside the earcup have two things in common: 1) they do not maximize the amount of absorptive attenuation by fully occupying the interior of the earcup with open cell foam and simultaneously preventing the addition of new acoustic cavities and interference with the ear, and 2) they are relatively easy to manufacture. Traditional foam insert design has been largely restricted to 2-dimensional die cut foam shapes because they are easy to manufacture. However, nearly all earcups on the market are designed with three-dimensional curved interiors, into which 2-dimensional die cut shapes can never properly fit.

U.S. Pat. No. 4,972,491 issued to Wilcox (herein, “the Wilcox Patent”) describes a combination hearing protector and communications headset where the earplug delivers the communication signal and the system has been ruggedized for military usage. The Wilcox Patent discloses that increasing the thickness of the foam in the earcup cavity increases the hearing protection to the user. However, the Wilcox Patent does not point out the importance of the type of foam, the specific shape of the foam, the need to reduce the number of acoustic cavities and sharp angles, and the need to keep the external ear (pinna) free from contact.

U.S. Pat. No. 4,658,931 issued to Curry (herein, the “Curry Patent”) describes a circumaural hearing protector utilizing a double walled structure that creates a vacuum between the ear and the ambient environment. The Curry Patent does not discuss the need for any foam attenuation means. However, the structural interaction between the walls and the leak between the seal and the head will likely limit the realizable attenuation at the ear canal. The Curry Patent provides no data that indicates an improvement in attenuation was realized through his invention.

U.S. Pat. No. 5,815,842 issued to Hiselius (the “Hiselius Patent”) describes a series of chambers that are created inside the earcup to effectively dissipate energy and damp interior acoustic resonances. The Hiselius Patent incorporates a foam insert adjacent to the opening of the earcup but does not describe the importance of the type of foam, the specific shape of the foam, the need to reduce the number of acoustic cavities and sharp angles, and the need to keep the external ear (pinna) free from contact.

U.S. Pat. No. 5,792,998 issued to Gardner et al. (herein, the “Gardner Patent”) describes the manufacture and usage of a dynamically stiff foam designed to improve attenuation of hearing protectors. This foam is designed to minimize vibration while also remaining statically soft to ensure maximum comfort. This foam is designed for minimizing the vibration mode of hearing protectors as opposed to absorbing sound. The Gardner Patent does not teach the usage of foam for acoustic absorption inside an earcup. Furthermore, no mention is made of specially designing acoustic absorption foam to improve hearing protection inside the earcup. Their foam is used in seals for circumaural headsets and in making earplugs.

U.S. Pat. No. 4,114,197 issued to Morton (herein, the “Morton Patent”) describes a helmet that is designed specifically for an individual by using resilient expandable plastic foam to form fit the helmet to the user's head. Here, the foam is not used as a primary means of attenuation, but instead to apply pressure on the earcup to achieve hearing protection through an effective seal. The foam's primary purpose is to achieve a customized fit between the helmet and the user's head.

What is needed is an acoustic foam insert that improves overall attenuation without interfering with the user, that can be shaped to conform to the three-dimensional contours of the earcup, and that can be manufactured in a repeatable manner.

### SUMMARY OF INVENTION

Embodiments of the present invention provide an acoustic foam insert that improves overall attenuation without interfering with the external ear of the user, that can be shaped to conform to the three-dimensional contours of the earcup, and that can be manufactured in a repeatable manner. It is therefore an aspect of the present invention to provide an acoustic foam insert that improves overall attenuation and improves attenuation performance across users.

Another aspect of the present invention is a three dimensional shaped foam insert that occupies a maximum amount of interior volume inside an earcup without interfering with the wearer's pinna.

Another aspect of the present invention is a foam insert that can be used to improve the acoustic noise attenuation properties for any shaped circumaural earcup.

Another aspect of the present invention is a method of manufacturing a foam insert that permits a concave portion of foam to be removed from a block of foam material so as to provide a non-rigid, curvilinear acoustic cavity in the area of the foam insert immediately surrounding the external ear.

It is yet another aspect of the present invention to manufacture in a repeatable manner a foam insert with a concave-shaped portion removed.

These and other objects of the present invention will be more readily apparent when considered in reference to the following description and when taken in conjunction with the accompanying drawings.

An embodiment of the present invention is a shaped acoustic foam insert for use in an earcup of a circumaural hearing protector. The shaped acoustic foam insert comprises a cross-section and shape adapted to occupy the entire interior volume of the earcup and has no folds or open acoustic cavities. A curvilinear groove is cut in a surface of the insert facing the pinna of a user of the circumaural hearing protector, wherein the curvilinear groove accommodates the average human pinna and has no sharp angles. In another embodiment of the present invention, the shaped acoustic foam insert is formed from a solid piece of acoustic foam. The insert may be formed from open cell foam or closed cell foam and may be externally shaped to fit exactly within a specific earcup interior shape.

Other embodiments of the present invention provide a system for manufacturing a shaped acoustic foam insert for use in an earcup of a circumaural hearing protector. The system comprises a top assembly comprising a rectangular top plate circumscribed by four side plates, wherein the top plate comprises an opening that is the same size as the opening in the circumaural earcup. A bottom fixture has an opening of sufficient size to receive a foam block. The opening in the top plate and the opening in the bottom plate are adjustable relative to each other. A bottom plate is situated under the bottom fixture and adapted to retain the foam block. Means are provided to align the top plate and the bottom fixture and to lock the alignment in place as are means to compress the top plate and bottom fixture to expose a portion of the foam block for removal. Optionally, the acoustic foam block is cut to a prescribed thickness through a process known as skiving and to have rounded corners.

Other embodiments of the present invention provide a method of manufacturing a shaped acoustic foam insert for use in an earcup of a circumaural hearing protector. The method comprises cutting a foam block to completely fill the earcup, and forming in a surface of the foam block facing an ear of a user of the circumaural hearing protector a curvilinear groove that accommodates the average human pinna and has no sharp angles. In another embodiment of the present invention, the shaped acoustic foam insert is formed from a solid piece of acoustic foam. The insert may be formed from open cell foam or closed cell foam and may be shaped to accommodate a specific earcup shape.

### DESCRIPTION OF THE DRAWINGS

FIG. 1 illustrates a three-dimensional view of an implementation of a circumaural earcup containing a prior art foam insert cross covering the interior surface area of the earcup.

FIGS. 2 and 3 illustrate left and front cross sections of the earcup and prior art foam insert of FIG. 1.

FIG. 4 illustrates the prior art foam insert of FIG. 1 as it appears before insertion into the earcup.

FIG. 5 illustrates a three-dimensional view of another prior art implementation of a circumaural earcup containing a prior art foam insert block covering the interior surface area of the earcup.

FIG. 6 illustrates an isometric view of the prior art foam insert for the prior art earcup of FIG. 5.

FIG. 7 illustrates an isometric view of an earcup with a foam insert installed according to embodiments of the present invention.

FIGS. 8 and 9 illustrate left and front cross sections of the earcup and foam insert of FIG. 7 according to embodiments of the present invention.

FIG. 10 illustrates an isometric view of a foam insert according to embodiments of the present invention.

FIG. 11 illustrates an isometric view of a foam insert according to embodiments of the present invention prior to removal of a concave section.

FIG. 12 illustrates an isometric view of the cutting fixture of FIG. 12 with the foam insert of FIG. 11 in place before the compression of the foam insert takes place.

FIG. 13 illustrates a side view of the foam insert of FIG. 11 compressed in the cutting fixture of FIG. 12 such that a portion of the foam insert protrudes from the top of the fixture.

FIG. 14 illustrates a process for producing a foam insert according to embodiments of the present invention.

### DETAILED DESCRIPTION

Embodiments of the present invention provide an acoustic foam insert that improves overall attenuation without interfering with the user, that can be shaped to conform to the three-dimensional contours of the earcup, and that can be manufactured simply and reliably.

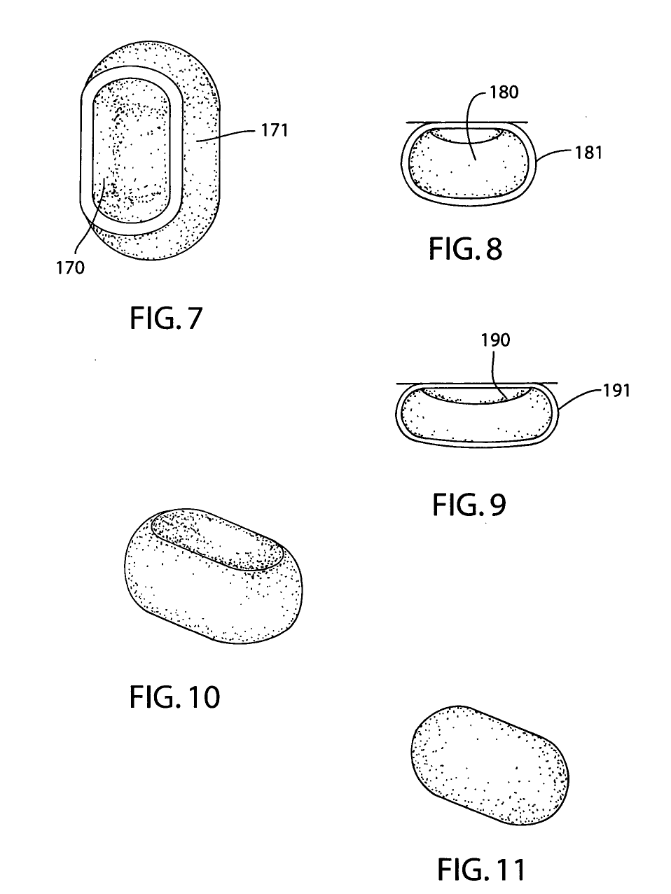

FIG. 7 illustrates an isometric view of an earcup 171 with the three-dimensional foam insert 170 inside. FIGS. 8 and 9 illustrate cross sectional views of the earcup 181, 191 with the new foam insert 180, 190 inside. The open cell foam is first cut to have the same exterior dimensions as the interior dimensions of the earcup. An isometric view of the foam is illustrated in FIG. 11. Because the foam is flexible, it can be compressed to fit through the hole in the earcup. Typically the hole to the interior of the earcup is smaller than the largest interior dimension of the earcup to result in a small projected surface area on the ear and a large cup interior volume.

The foam is first die cut from a single solid piece of foam to have the largest outer dimension equal to the largest interior dimension of the earcup. This results in a foam piece much like that illustrated in FIG. 6, but is cut to have the same depth as the earcup leaving no interior surface without foam contact. Because the interior surface of the earcup is curved in all dimensions, a filleted cut on both the top and bottom is required to form the same outer shape on the foam, as the interior dimensions of the earcup, resulting in the solid foam insert shape illustrated in FIG. 11. The technique for cutting such radii from a piece of solid foam is well known in the prior art.

As previously stated, it is important that the foam insert not contact the user's pinnae, which protrude from the user's head. In an embodiment of the present invention, a portion of the foam insert is removed such that the common pinna does not interfere with the foam insert. According to methods of the present invention, a three-dimensional curvilinear groove is removed from the foam insert such that rigid boundary conditions or corners do not remain in the foam insert. Such rigid boundaries and corners may generate lightly damped resonances. This is expressed in the cross sections of FIG. 8 and FIG. 9 and illustrated in an isometric view in 170 and FIG. 10. The required depth of the groove will be dependent upon the thickness of the ear seal and the average that the human pinna extends from the head. The interior radius that is formed will also depend on the required depth and clearance, but should be kept large enough to avoid introducing any interior standing waves, and small enough to maximize the amount of foam that occupies the interior of the ear cup.

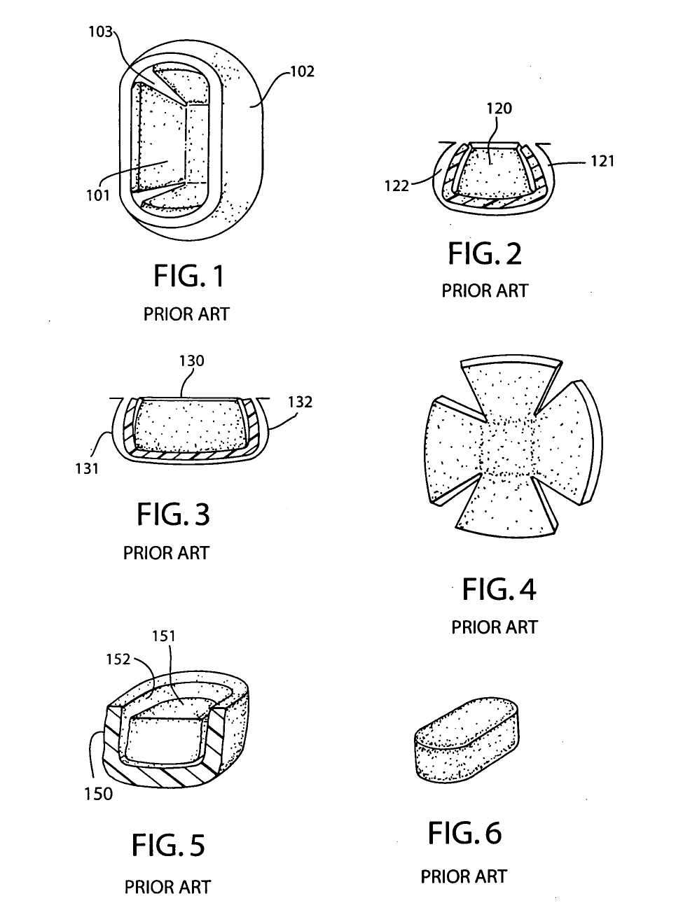

A foam insert according to embodiments of the present invention is illustrated in FIG. 10. The foam insert fills the entire interior portion of the earcup while leaving just enough room for the average pinna to avoid contact, assuming a specific seal thickness. This foam insert has been scientifically tested in an earcup with a standardized seal, versus a system as illustrated in FIG. 1. Clear improvement in attenuation performance and in standard deviation of attenuations was measured across a population of users using the real ear attenuation at threshold (REAT) test. This interior foam insert works better for a variety of reasons. Fewer creases and holes remove cavity resonances. At higher frequencies, lightly damped interior cup resonances effectively reduce attenuation performance. Including the fitted full-cup foam insert improves damping of these resonances and thereby increases the narrowband attenuation results. Creating curved surfaces on the exterior of the foam insert reduces the ability of standing waves to become overly resonant, ultimately increasing the attenuation. Maximizing the amount of foam material will inevitably result in more absorption of sound that is already present inside the earcup, and will increase the transmission loss for sounds coming through the earcup wall. Additional foam will also effectively increase the stiffness of the interior cup volume resulting in a possible increase in low frequency attenuation performance. A very slight increase in mass will also increase the high frequency attenuation.

While the foam insert described above has a defined earcup shape, the present invention is not so limited. As will be appreciated by those skilled in the art, a foam insert may be created for earcups having different geometries without departing from the scope of the present invention. The exterior dimensions of the foam insert should be equal to or very slightly greater than the interior dimensions of the earcup. This will ensure a positive connection point for the foam insert to be held in place inside the earcup. In addition, a curved groove should be cut to minimize contact with the user's pinnae when the headset is on and the foam insert is in place.

In an embodiment of the present invention, the foam insert is manufactured from a single piece of solid foam material. This method of manufacture reduces the chances for creases and folds forming, which may adversely affect attenuation. Manufacturing the foam insert from two or more pieces that are subsequently assembled may also introduce unwanted acoustic cavities or adhesive boundaries that could act as unwanted acoustic boundaries.

These performance improvements can all result in an improvement in the mean attenuation values measured in certain frequency bands. However, improved foam absorption can also improve the standard deviation. The most common variable from person to person is the shape of the head around the pinnae. Most earcups are flat with flexible seal material that is used to conform to the head around the pinna and establish a uniform seal between the earcup and the head. In practice a perfect seal is never established and a leak becomes the primary limiting factor in achieving high attenuation at all frequencies. This leak size can vary substantially from person to person, and therefore result in significantly different attenuation values when a hearing protector is measured across a population. The leak allows sound at all frequencies to enter into the earcup. Additional foam absorption inside the earcup will be more effective at reducing the impact of that interior noise on the overall exposure to the ear canal. Therefore, the attenuation variation among users due to changes in the leak size is reduced somewhat by the presence of additional foam and thereby reduces the standard deviation measured across a population.

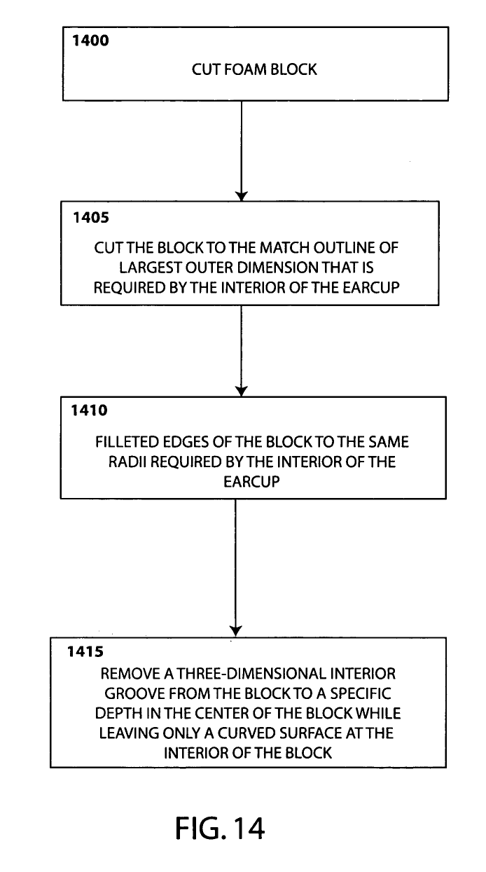

One possible reason that such a foam insert design has not been proposed in the past is the difficulty in realizing an inexpensive and simple manufacturing method for cutting a concave shape in the foam, in a repeatable manner, as that which is illustrated in FIG. 10. An embodiment of the present invention is a method for removing a concave-shaped portion of foam from a block of foam material. Referring to FIG. 14, a process for producing a foam insert is illustrated according to embodiments of the present invention. A foam block is cut from suitable foam material 1400, the foam block conforming to the size of the earcup into which it will be installed. A sheet of foam is cut to the desired thickness in a process referred to as skiving. Once the sheet is cut, a die tool is used to cut the outline of the largest outer dimension that is required by the interior of the earcup 1405, much like cutting a cookie from a sheet of dough. The edges of the thick foam piece are filleted 1410 using the same radii required by the interior of the earcup.

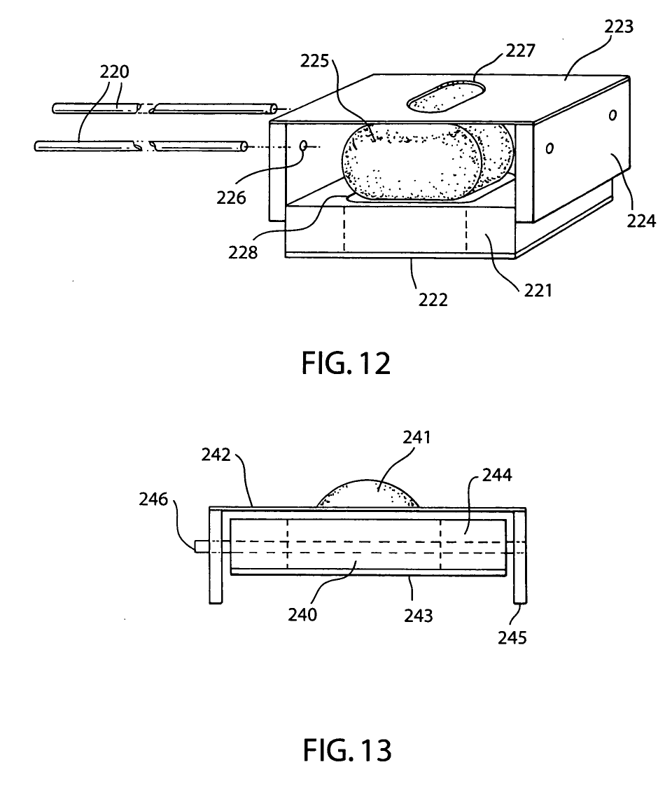

A three-dimensional interior groove is removed 1415 to a specific depth in the center while leaving only a curved surface at the interior of the foam insert for reasons described above. FIGS. 12 and 13 illustrate a new tool that has been developed to manufacture this particular interior cut.

FIG. 12 illustrates a two part clamping mechanism. The bottom fixture 221 has a center cut out 228 that accommodates the largest outer dimensions of the foam insert piece 225. (See, FIG. 11.) Attached to the bottom fixture 221 is a bottom plate 222 that prevents the foam insert piece 225 from coming through the hole 228. A top assembly 260 of the clamping mechanism comprises a top plate 223 and four side plates 224 that encircle the perimeter of the top plate. In FIG. 12 only two of the four side plates are visible for illustration purposes only. The top plate 223 has a hole 227 cut to exactly match the opening of the earcup into which the foam insert will ultimately be placed. By way of example and not as a limitation, the hole 227 will exactly match the opening of the earcup 171 in FIG. 7. According to the design of the earcup, the hole 227 in the top plate 223 is concentric with the center cut- out 228 in the bottom fixture 221.

Most earcups are symmetric in this way, but if they are not, the hole 227 in the top plate may be positioned in a manner that lines up correctly with the center cut out 228 in the bottom fixture 221 in accordance with the earcup design. This is accomplished by positioning the sides 224 of the top assembly 260 such that they slide around the outer dimensions of the bottom fixture 221. By design, the hole 227 will be accurately positioned over the bottom hole because the outer dimensions of the bottom fixture 221 fit exactly into the inner dimensions formed by the sides 224 of the top assembly 260.

The foam insert piece 225 is placed in the hole 228 in the bottom fixture 221 and is compressed by pressing the top plate 223 until it touches the top of the bottom fixture 221. Alignment and locking mechanisms, for example the alignment holes 226 and alignment locking rods 220, are used to keep the top plate connected to the bottom fixture when compressed. The locking rods 220 are inserted through corresponding holes in the side plates 224 which also extend through the body of the base 221.

FIG. 13 illustrates a sectional view of the compressed foam insert and locking mechanism with the locking rods in place. The foam insert piece 225 is compressed into the cavity of the bottom fixture 221. Because the earcup opening is smaller than the maximum outer dimensions of the earcup, a portion of the foam insert piece 241 extends beyond the top plate 223. This extended portion 241 of the foam insert is compressed more on its perimeter than in the center, leaving a larger depth of foam extending in the center of the top plate hole. With the locking rods 220 securing the bottom fixture 221 through the side plates 224, the bottom plate 222 ensures that the extended portion 241 of foam insert piece 225 is compressed inside the bottom fixture 221. The extended portion 241 is then removed by using a razor, band saw or other foam cutting tool so that the cutting plane is parallel to and directly against the top plate 223.

Once the foam insert is cut the resulting space is a curve that is nearly the inverse of the extend portion 241 of foam protruding from the top plate 223. FIG. 11 and FIG. 10 illustrate the foam insert piece and the completed foam insert respectively. The center depth of this cut is controlled by the amount of compression that is applied to the foam insert, which also in turn controls the radius of the cut between the outer edge and the deepest depth. The desired depth of the cut depends on the average pinnae size, the depth of the earcup, and the thickness of the ear seal. This is controlled by the designer by adjusting the thickness of the bottom fixture; the thicker the fixture with respect to the overall foam thickness, the shallower the depth of cut.

The foam insert providing improved noise protection through an increase in attenuation and a decrease in standard deviation among users has now been described. Additionally, a method for manufacturing the foam insert has also been described. It will also be understood that the invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

1. A shaped acoustic foam insert for use in an earcup of a circumaural hearing protector comprising:
a cross-section and shape adapted to occupy the entire interior volume of the earcup, the insert having no folds or open acoustic cavities, and
a curvilinear groove cut in a surface facing an ear of a user of the circumaural hearing protector, wherein the curvilinear groove accommodates the average human pinna and has no sharp angles.

2. The shaped acoustic foam insert as in claim 1, wherein the shaped acoustic foam insert is formed from a solid piece of acoustic foam.

3. The shaped acoustic foam insert as in claim 1, wherein the shaped acoustic foam insert is formed from open cell foam.

4. The shaped acoustic foam insert as in claim 1, wherein the shaped acoustic foam insert is formed from closed cell foam.

5. The shaped acoustic foam insert as in claim 1, wherein the shaped acoustic foam insert is shaped to accommodate a specific earcup shape.

6. A system for manufacturing a shaped acoustic foam insert for use in an earcup of a circumaural hearing protector comprising:
a top assembly comprising a rectangular top plate circumscribed by four side plates, wherein the top plate comprises an opening that is the same size as the opening in the circumaural earcup;
a bottom fixture having an opening of sufficient size to receive a foam block, wherein the opening in the top plate and the opening in the bottom plate are adjustable relative to each other;
a bottom plate situated under the bottom fixture and adapted to retain the foam block;
means to align the top plate and the bottom fixture and to lock the alignment in place; and
means to compress the top plate and bottom fixture to expose a portion of the foam block for removal.

7. The system of claim 6 wherein the acoustic foam block is cut to a prescribed thickness through a process known as skiving.

8. The system of claim 6 wherein the acoustic foam block is cut to have rounded corners to fit the shape of the earcup.

9. A method of manufacturing a shaped acoustic foam insert for use in an earcup of a circumaural hearing protector comprising:
cutting a foam block to completely fill the earcup; and
forming in a surface of the foam block facing an ear of a user of the circumaural hearing protector a curvilinear groove that accommodates the average human pinna and has no sharp angles.

10. The shaped foam as in claim 9, wherein the foam block is formed from open cell foam.

11. The method of manufacturing a shaped acoustic foam insert as in claim 9, wherein the foam block is formed from closed cell foam.

12. The method of manufacturing a shaped acoustic foam insert as in claim 9, wherein the foam block is shaped to accommodate a specific earcup shape.

13. The method of manufacturing a shaped acoustic foam insert as in claim 9, wherein the foam block is a solid piece of acoustic foam.
